(19) United States
(12) Patent Application Publication
(10) Pub. No.: US 2020/0319656 A1
(43) Pub. Date: Oct. 8, 2020

(54) COMMUNICATION METHOD AND DEVICE, WATER PUMP, UNMANNED AERIAL VEHICLE, AND COMPUTER-READABLE STORAGE MEDIUM

(71) Applicant: SZ DJI TECHNOLOGY CO., LTD., Shenzhen (CN)

(72) Inventors: Zhaohui FANG, Shenzhen (CN); Lun PAN, Shenzhen (CN); Gang HE, Shenzhen (CN)

(21) Appl. No.: 16/905,123

(22) Filed: Jun. 18, 2020

Related U.S. Application Data
(63) Continuation of application No. PCT/CN2017/117012, filed on Dec. 18, 2017.

(51) Int. Cl. G05D 1/10; H04B 7/185; G05D 1/00; B64D 1/18; B64C 39/02; F04D 15/00

(52) U.S. Cl. CPC G05D 1/101; H04B 7/18506; G05D 1/0094; B64C 2201/12; B64C 39/024; F04D 15/00; B64D 1/18

(57) ABSTRACT

A communication method for a water pump includes detecting whether the water pump receives connection data transmitted by a first control system after the water pump is powered on. The communication method also includes determining a target communication mode of the water pump based on the connection data, in response to a detection that the water pump receives the connection data and that a communication mode of the first control system is the same as a current communication mode of the water pump. The communication method further includes communicating with a second control system indicated by the connection data based on the target communication mode.

### CROSS-REFERENCE TO RELATED APPLICATION

This application is a continuation application of International Application No. PCT/CN2017/117012, filed on Dec. 18, 2017, the entire content of which is incorporated herein by reference.

### TECHNICAL FIELD

The present disclosure relates to the technology field of communication and, more particularly, to a communication method and device, a water pump, an unmanned aerial vehicle, and a computer-readable storage medium.

### BACKGROUND

Agricultural unmanned aerial vehicles (“UAVs”) have become increasingly popular due to their high-efficiency working mode, safety, and convenience, and other advantages. Agricultural UAVs have a huge room for future development.

Currently, agricultural UAVs are primarily used to spray fluids. Therefore, water pumps are the key assemblies for implementing fluid spraying, which are also the most frequently used devices in practical operations. In general, when a water pump is damaged, it may be desirable to determine the damages, the cause of the damages, and the responsibility for the damages. However, because it is difficult to obtain operation information relating to the operations of the water pump, oftentimes, the examination of the water pump can only rely on simple manufacturing information, which makes it difficult to pinpoint the detailed cause of the pump damages. In addition, to develop more reliable water pumps, the operation information of the water pumps is needed. Based on the operation information, how the water pump was operated may be analyzed and investigated. However, it is an emerging issue on how to develop a water pump control system that can obtain the related operation information of the water pump through a simple, fast, and straightforward manner.

### SUMMARY

In accordance with an aspect of the present disclosure, there is provided a communication method for a water pump. The communication method includes detecting whether the water pump receives connection data transmitted by a first control system after the water pump is powered on. The communication method also includes determining a target communication mode of the water pump based on the connection data, in response to a detection that the water pump receives the connection data, and that a communication mode of the first control system is the same as a current communication mode of the water pump. The communication method further includes communicating with a second control system indicated by the connection data based on the target communication mode.

In accordance with another aspect of the present disclosure, there is also provided a water pump. The water pump includes a communication interface and a processor. The processor is configured to detect whether the water pump receives connection data transmitted by a first control system after the water pump is powered on. The processor is also configured to determine a target communication mode of the water pump based on the connection data, after detecting that the water pump receives the connection data and that a communication mode of the first control system is the same as a current communication mode of the water pump. The communication interface is configured to communicate with a second control system indicated by the connection data based on the target communication mode.

In accordance with another aspect of the present disclosure, there is also provided an unmanned aerial vehicle. The unmanned aerial vehicle includes a flight control system configured to control flight of the unmanned aerial vehicle and a water pump coupled with the flight control system. The water pump includes a communication interface and a processor. The processor is configured to detect whether the water pump receives connection data transmitted by the flight control system after the water pump is powered on. The processor is also configured to determine a target communication mode of the water pump based on the connection data, after detecting that the water pump receives the connection data, and that a communication mode of the flight control system is the same as a current communication mode of the water pump. The communication interface is configured to communicate with another control system indicated by the connection data based on the target communication mode.

The technical solutions of the present disclosure have the following advantages:

the present disclosure provides a communication method. The water pump may receive a connection data transmitted by a first control system. When a communication mode of the first control system and a current communication mode of the water pump are the same, a target communication mode of the water pump may be determined based on the connection data. The water pump may communicate with a second control system indicated by the connection data based on the target communication mode. As such, through the communication method, the second control system may communicate with the water pump, and may obtain related operation information of the water pump through a simple, straightforward, and convenient manner, rather than simply obtaining the manufacturing information. The second control system may analyze and investigate the operations of the water pump based on the obtained operation information, and may timely determine the damages, the cause of the damages, and the responsibility for the damages when the water pump is damaged. In some embodiments, one or more communication modes may be provided at the water pump, and switching between multiple communication modes may be supported to enable the water pump to fit with multiple operation scenes.

### BRIEF DESCRIPTION OF THE DRAWINGS

The present disclosure provides a communication method and device, a water pump, a UAV, and a computer-readable storage medium, configured to provide a stable and reliable communication mode to realize reliable transmission of related operation information of the water pump.

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a communication method, according to an example embodiment.

FIG. 2 is a flow chart illustrating a communication method, according to another example embodiment.

FIG. 3 is a flow chart illustrating a communication method, according to another example embodiment.

FIG. 4 is a flow chart illustrating a communication method, according to another example embodiment.

FIG. 5 is a flow chart illustrating a communication method, according to another example embodiment.

FIG. 6 is a flow chart illustrating a communication method, according to another example embodiment.

FIG. 7 is a flow chart illustrating a communication method, according to another example embodiment.

FIG. 8 is a flow chart illustrating a communication method, according to another example embodiment.

FIG. 9 is a flow chart illustrating a communication method, according to another example embodiment.

FIG. 10 is an interactive diagram illustrating a communication method, according to an example embodiment.

FIG. 11 is a schematic diagram of a UAV, according to an example embodiment.

FIG. 12 is an interactive diagram illustrating a communication method, according to another example embodiment.

FIG. 13 is a schematic diagram of a communication frame based on the communication method shown in FIG. 12, according to an example embodiment.

FIG. 14 is a schematic diagram of a communication device, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be understood that in the present disclosure, relational terms such as “first,” “second,” “third,” and “fourth,” etc., are only used to distinguish an entity or operation from another entity or operation, and do not necessarily imply that there is an actual relationship or order between the entities or operations. It should be understood that data modified by the “first,” “second,” “third,” or “fourth” may be interchangeable in certain conditions, such that the embodiments described herein may be executed in orders other than those illustrated or described herein. And, the terms “comprise,” “comprising,” “include,” and the like specify the presence of stated features, steps, operations, elements, and/or components but do not preclude the presence or addition of one or more other features, steps, operations, elements, components, and/or groups.

In addition, the singular forms “a,” “an,” and “the” are intended to include the plural forms as well, unless the context indicates otherwise. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

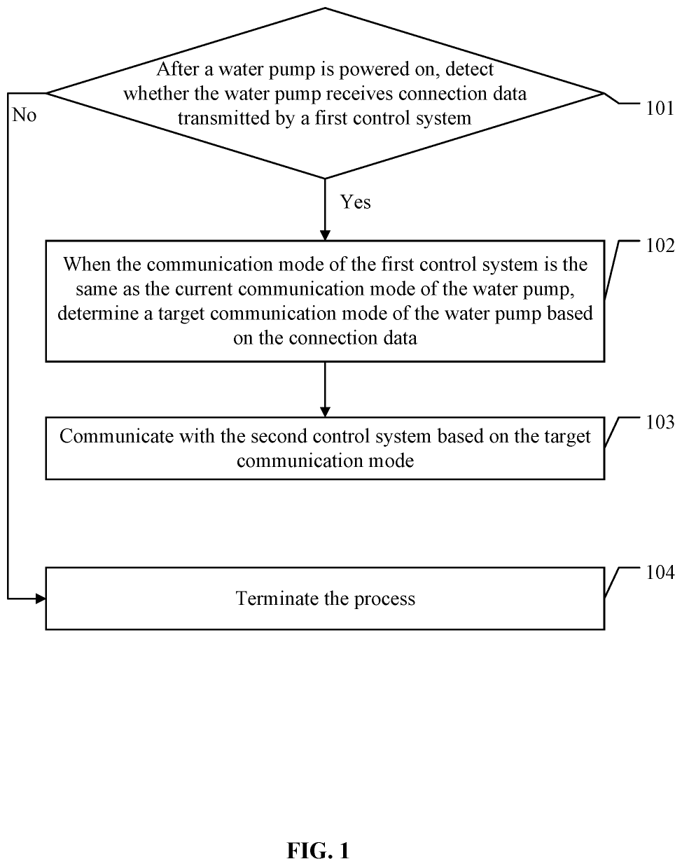

For the convenience of understanding, next the detailed processes of the present disclosure will be described. Referring to FIG. 1, the present disclosure provides a communication method. An embodiment of the disclosed communication method may include:

Step 101: after a water pump is powered on, detecting whether the water pump receives (including is receiving or has received) connection data transmitted by a first control system; if the connection data are received, step 102 is executed; otherwise, step 104 is executed.

In some embodiments, a movable platform may include a water pump configured to spray fluids. The water pump may be provided with a chip to realize communication with a control system. To provide related operation information of the water pump to the control system, after the water pump is powered on, a detector corresponding to the disclosed method may detect whether the water pump receives (e.g., is receiving or has received) the connection data transmitted by the first control system. One or more communication modes may be provided at the water pump for different scenes and hardware.

In some embodiments, when a second control system needs to obtain the related operation information of the water pump, the first control system may transmit the connection data to the water pump to instruct the water pump to communicate with the second control system based on a corresponding communication mode. In some embodiments, after the water pump is powered on, the first control system may have not transmitted the connection data to the water pump. Then the water pump may not need to communicate with an external device, so as to avoid waste of communication resources. Therefore, after the water pump is powered on, the detector may detect whether the water pump receives the connection data transmitted by the first control system.

In some embodiments, the first control system and the second control system may be the same, or may be different. The present disclosure does not limit the first control system and the second control system.

In some embodiments, at least one of the first control system or the second control system may be provided on the movable platform, or may not be provided on the movable platform, which is not limited in the present disclosure.

Step 102: when the communication mode of the first control system is the same as the current communication mode of the water pump, determining a target communication mode of the water pump based on the connection data.

In some embodiments, when the water pump receives the connection data transmitted by the first control system, the water pump may further detect whether the communication mode of the first control system is the same as the current communication mode of the water pump. If the communication mode of the first control system is the same as the current communication mode of the water pump, a target communication mode of the water pump may be determined based on the received connection data.

In some embodiments, when the water pump has one or more communication modes, the communication mode of the first control system may be different from the current communication mode of the water pump. When the communication mode of the first control system is different from the current communication mode of the water pump, it is possible that the water pump may not be able to interpret the received connection data or may interpret the received connection data in an incorrect way, and hence, may not perform corresponding communication based on the connection data. Therefore, after the water pump receives the connection data, if the communication mode of the first control system is the same as the current communication mode of the water pump, then the water pump can correctly interpret the received connection data and may determine the target communication mode of the water pump based on the connection data.

In some embodiments, based on a relationship between the first control system and the second control system and the received connection data, the current communication mode of the water pump may or may not be the same as the target communication mode of the water pump, which is not limited in the present disclosure.

Step 103: communicating with the second control system based on the target communication mode.

In some embodiments, after the target communication mode of the water pump is determined, the water pump may communicate with the second control system based on the target communication mode. The second control system may be indicated by the connection data.

In some embodiments, the connection data may not only indicate a target communication object of the water pump, but also indicate a target communication mode for communicating with the target communication object, as well as content for the communication between the water pump and the target communication object. The target communication object may be a second control system that may be the same as the first control system, or may be a second control system that may be different from the first control system, which are respectively described below:

First situation: a first control system A transmits connection data to a water pump B in a communication mode A1. After the water pump B receives the connection data, if the current communication mode of the water pump B is also A1, then after the water pump B interprets the connection data, the water pump B may determine a target communication mode A1 based on the connection data. The water pump B may communicate with a second control system A (i.e., the second control system is the same as the first control system A) based on the target communication mode A1, to exchange related communication information.

Second situation: the first control system A transmits the connection data to the water pump B based on the communication mode A1. After the water pump B receives the connection data, if the current communication mode of the water pump B is also A1, then after the water pump B interprets the connection data, the water pump B may determine a target communication mode A2 based on the connection data (A2 may or may not be the same as A1). The water pump B may communicate with a second control system C indicated by the connection data based on the target communication mode A2, to exchange related communication information.

In some embodiments, when the target communication mode A2 is different from the current communication mode A1 of the water pump B, the current communication mode A1 of the water pump B may be switched to the target communication mode A2. Before the switch, the related hardware may be initialized in order to realize the switch between A1 and A2.

Step 104: terminating the process.

In some embodiments, if the water pump does not receive the connection data transmitted by the first control system, then other steps may not be performed, and the process may be terminated.

In some embodiments, if the water pump does not receive the connection data transmitted by the first control system, other operations may be performed, such as detecting whether there exist the connection data transmitted by the first control system. The present disclosure does not limit the other operations.

In some embodiments, when the communication mode of the first control system is different from the current communication mode of the water pump, step 104 may also be performed, which is not limited in the present disclosure.

In some embodiments, the water pump receives the connection data transmitted by the first control system. When the communication mode of the first control system is the same as the current communication mode of the water pump, the water pump may determine a target communication mode based on the connection data, and may communicate with a second control system indicated by the connection data based on the target communication mode. Through the disclosed communication method, the second control system may communicate with the water pump, and may obtain related operation information of the water pump in a simple, straightforward, and convenient manner, rather than merely obtaining the manufacturing information. As a result, the second control system may analyze and investigate the operations of the water pump based on the obtained communication information (including the operation information), and may timely determine damages, cause of the damages, and responsibility for the damages when the water pump is damaged. As described, one or more communication modes may be provided at the water pump. Switch between the communication modes may be supported, which may render the water pump suitable for multiple operation scenes.

In some embodiments, after receiving the connection data transmitted by the first control system, the water pump may detect whether the communication mode of the first control system is the same as the current communication mode of the water pump. When the water pump does not receive the connection data transmitted by the first control system or when the connection data do not satisfy a predetermined condition, different operations may be performed, as explained below:

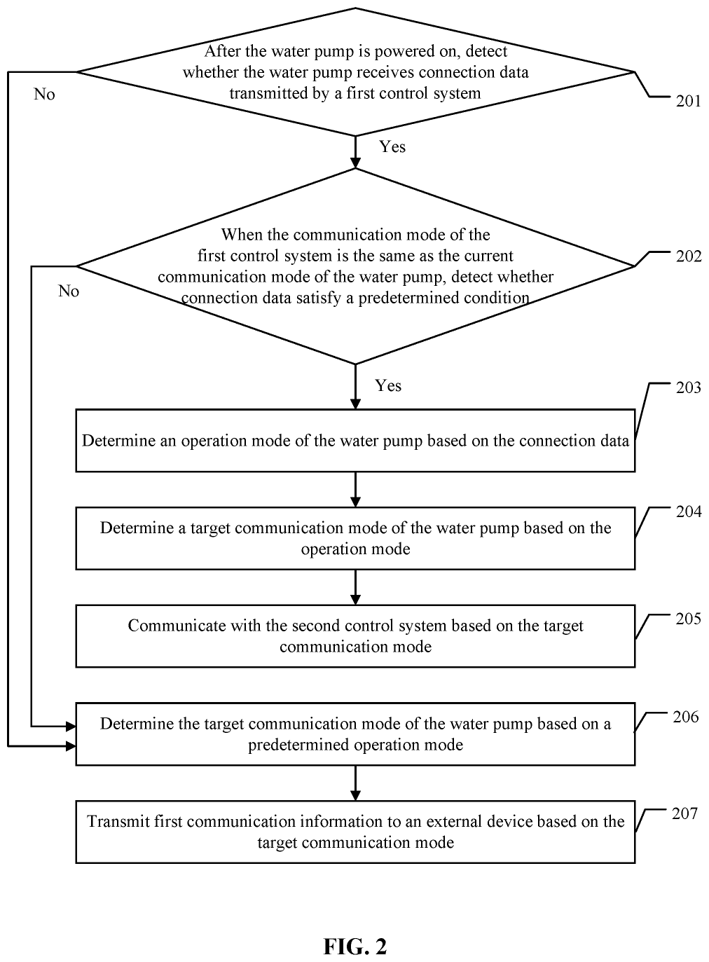

Referring to FIG. 2, another embodiment of the communication method may include:

Step 201: after the water pump is powered on, detecting whether the water pump receives connection data transmitted by a first control system; if the connection data are received, step 202 may be performed; otherwise, step 206 may be performed.

In some embodiments, step 201 may be the same as step 101 of FIG. 1. Thus, the descriptions of step 201 may refer to the descriptions of step 101.

In some embodiments, after the water pump is powered on, before detecting whether the water pump receives the connection data transmitted by the first control system, to increase the possibility of matching between the current communication mode of the water pump and the communication mode of the first control system, the current communication mode of the water pump may be switched based on a second predetermined rule.

In some embodiments, the second predetermined rule may be determined or configured based on actual needs. For example, the second predetermined rule may include switching between multiple communication modes in turn, switching between the multiple communication modes based on an order from high frequency of use to low frequency of use, or switching from the last used communication mode. The present disclosure does not limit the second predetermined rule.

Step 202: when the communication mode of the first control system is the same as the current communication mode of the water pump, detecting whether the connection data satisfy a predetermined condition; if the connection data satisfy the predetermined condition, step 203 may be performed; otherwise, step 206 may be performed.

In some embodiments, if the water pump receives the connection data transmitted by the first control system, then when the communication mode of the first control system is the same as the current communication mode of the water pump, the water pump may further detect or determine whether the connection data satisfy the predetermined condition.

In some embodiments, because when the communication mode of the first control system is the same as the current communication mode of the water pump, the connection data may be correctly interpreted, then after the water pump receives the connection data transmitted by the first control system, the water pump may determine whether the communication mode of the first control system is the same as the current communication mode of the water pump based on the correctness of a result of interpreting the connection data. If the connection data are correctly interpreted, then by default, it indicates that the communication mode of the first control system is the same as the current communication mode of the water pump. Conversely, if the connection data are incorrectly interpreted, then by default, it indicates that the communication mode of the first control system is different from the current communication mode of the water pump.

In some embodiments, to avoid the water pump responding to any connection data transmitted by the first control system using the current communication mode of the water pump, the water pump may be provided with one or more communication modes. Different corresponding predetermined conditions may be set based on a classification of the communication modes. The predetermined conditions may be used as the standard to determine whether to respond to the connection data transmitted by the first control system. When the connection data satisfy a predetermined condition, the connection data may be correctly interpreted and the water pump may respond to the connection data. Conversely, the connection data may not be correctly interpreted and the water pump may not respond to the connection data.

In some embodiments, it is possible that the communication mode of the first control system is the same as the current communication mode of the water pump, but data features corresponding to the connection data may not satisfy a predetermined condition, which may cause the connection data to be not reliable. If the Baud rate of the connection data does not satisfy a predetermined condition, then to avoid data security issues that may be caused by such situations, the disclosed method may include performing related detections on the connection data before responding to the connection data.

In some embodiments, in addition to the above-described method for determining whether the communication mode of the first control system is the same as the current communication mode of the water pump, in some embodiments, other methods may also be used, as long as the methods can determine whether the communication mode of the first control system is the same as the current communication mode of the water pump. The present disclosure does not limit the methods for making such a determination.

Step 203: determining an operation mode of the water pump based on the connection data.

In some embodiments, if the connection data satisfy the predetermined condition, the operation mode of the water pump may be determined based on the connection data.

In some embodiments, determining the operation mode of the water pump based on the connection data may include:

determining content information of the connection data; and

determining the operation mode of the water pump based on the content information.

In some embodiments, when the connection data satisfy the predetermined condition, it indicates that the connection data may be correctly interpreted. Then, after the connection data are correctly interpreted, the content information of the connection data may be obtained. The content information may instruct the water pump to enter a corresponding operation mode. The corresponding operation mode may cause the water pump to perform related functions.

In some embodiments, one or more operation modes may be provided on the water pump. The operation modes may include, but not be limited to, one or more of a data output mode, a command input mode, a programming mode, and a data editing mode. The programming mode may include setting input commands. The data output mode may include outputting data to external devices. The command input mode may include receiving commands input from an external device. The data editing mode may include editing the output data.

Step 204: determining a target communication mode of the water pump based on the operation mode.

In some embodiments, after determining the operation mode of the water pump based on the connection data, a target communication mode of the water pump may be further determined based on the operation mode.

In some embodiments, in the connection data, an operation mode may correspond to a communication mode. The detailed operation mode and the communication mode corresponding to the operation mode may be configured by the first control system, and may be indicated by the connection data transmitted by the first control system. In some embodiments, after determining the operation mode of the water pump, the target communication mode of the water pump may also be determined.

Step 205: communicating with the second control system based on the target communication mode.

In some embodiments, step 205 may be the same as step 103 shown in FIG. 1. Thus, the descriptions of step 205 may refer to the descriptions of step 103.

In some embodiments, because corresponding operation mode may cause the water pump to perform a corresponding function, when the water pump communicates with the second control system based on the target communication mode, the water pump may execute corresponding functions of the operation mode. For example, when the operation mode of the water pump determined based on the connection data is the data output mode, and when the current operation mode of the water pump is not the data output mode, first, the current operation mode of the water pump may be switched to the data output mode, and then, the water pump may output data to the second control system based on the target communication mode, and execute functions corresponding to the data output mode.

Step 206: determining the target communication mode of the water pump based on a predetermined operation mode.

In some embodiments, if the water pump does not receive the connection data or the received connection data do not satisfy a predetermined condition, then the target communication mode of the water pump may be determined based on a predetermined operation mode.

In some embodiments, if the water pump does not receive the connection data or the received connection data do not satisfy the predetermined condition, the water pump may still output related data to an external device. In such situations, a predetermined operation mode may be configured at the water pump. The predetermined operation mode may correspond to a communication mode. Accordingly, the target communication mode of the water pump may be determined based on the predetermined operation mode.

In some embodiments, the predetermined operation mode may be a default operation mode among multiple operation modes provided at the water pump. The predetermined operation mode may be adjusted (e.g., changed to another one of the multiple operation modes).

In some embodiments, in addition to the above descriptions of the predetermined operation mode, in some embodiments, other methods may also be used to configure the predetermined operation mode. For example, an operation mode corresponding to the last communication between the water pump and the second control system may be set as the predetermined operation mode. As another example, the most frequently used operation mode of the water pump may be set as the predetermined operation mode. The present disclosure does not limit how the predetermined operation mode is set.

In some embodiments, the target communication mode may include, but not be limited to, communication based on one or more of a serial interface, an inter-integrated circuit (“IIC”), a serial peripheral interface (“SPI”), a l-wire bus, a controller area network (“CAN”) bus, and a pulse.

Step 207: transmitting first communication information to an external device based on the target communication mode.

In some embodiments, after determining the target communication mode of the water pump based on the predetermined operation mode, the water pump may transmit first communication information to an external device based on the target communication mode. The external device may be the second control system or any other device or system.

In some embodiments, if the water pump does not receive the connection data or the connection data do not satisfy the predetermined condition, it indicates that the water pump cannot obtain information on a communication object that communicates with the water pump. The water pump may still transmit the first communication information to an external device based on the target communication mode, such that when the second control system that communicates based on the target communication mode needs to obtain relevant information of the water pump, the second control system may obtain the first communication information.

In some embodiments, when the communication mode of the first control system is different from the current communication mode of the water pump, steps 206 and 207 may still be executed, which is not limited by the present disclosure.

In some embodiments, based on the embodiment shown in FIG. 1, the embodiment shown in FIG. 2 adds the detection on the received connection data, which may reduce the response of the water pump to the connection data that do not satisfy the predetermined condition. As a result, communication security is enhanced, the possibility of leakage of operational data of the water pump is decreased. Moreover, detailed subsequent operations are provided for the situation when the connection data are not received or when the received connection data do not satisfy the predetermined condition, thereby satisfying different communication scenes.

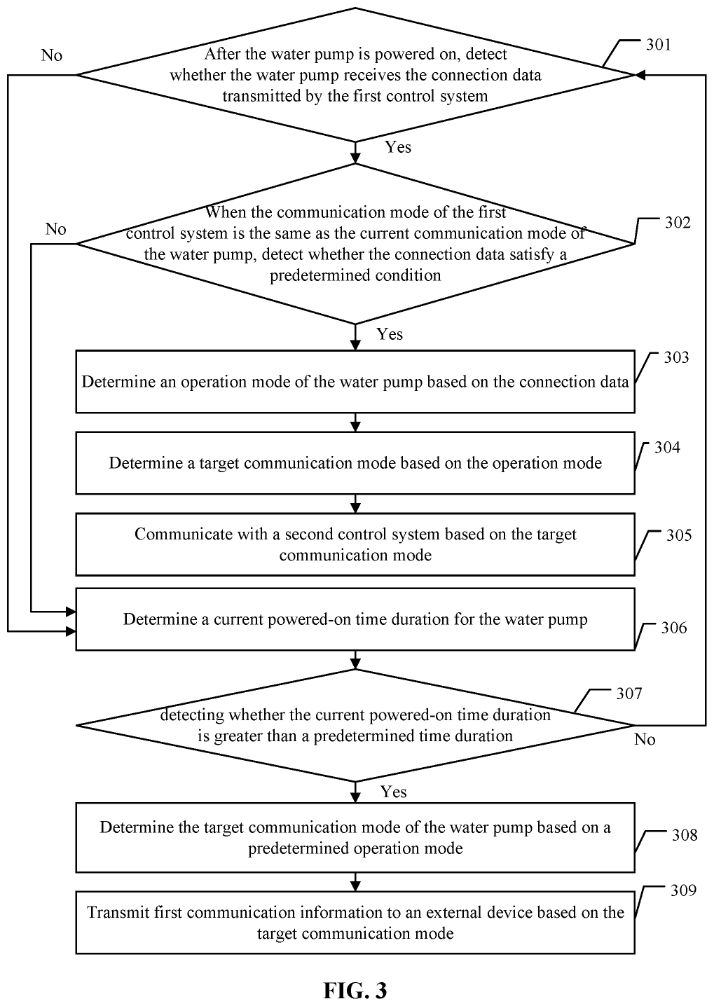

Referring to FIG. 3, another embodiment of the communication method may include:

Step 301: after the water pump is powered on, detecting whether the water pump receives the connection data transmitted by the first control system; if the water pump receives the connection data, step 302 may be executed; otherwise, step 306 may be executed.

Step 302: when the communication mode of the first control system is the same as the current communication mode of the water pump, detecting whether the connection data satisfy a predetermined condition; if the connection data satisfy the predetermined condition, step 303 may be executed; otherwise, step 306 may be executed.

Step 303: determining an operation mode of the water pump based on the connection data.

Step 304: determining a target communication mode based on the operation mode.

Step 305: communicating with a second control system based on the target communication mode.

In some embodiments, steps 301-305 may be the same as steps 201-205 shown in FIG. 2. Thus, descriptions of steps 301-305 may refer to the descriptions of steps 201-205.

Step 306: determining a current powered-on time duration for the water pump.

In some embodiments, if the water pump does not receive the connection data or if the received connection data do not satisfy the predetermined condition, a current powered-on time duration for the water pump may be determined.

Step 307: detecting (or determining) whether the current powered-on time duration is greater than a predetermined time duration. If the current powered-on time duration is not greater than the predetermined time duration, step 301 may be executed; if the current powered-on time duration is greater than the predetermined time duration, step 308 may be executed.

In some embodiments, after determining the current powered-on time duration for the water pump, whether the current powered-on time duration is greater than the predetermined time duration may be determined or detected.

In some embodiments, in order to communicate with the second control system indicated by the connection data based on the target communication mode, when the water pump does not receive the connection data or when the received connection data do not satisfy the predetermined condition, multiple detections may be performed to determine whether the connection data transmitted by the first control system are received or whether the received connection data satisfy the predetermined condition. The number of detections may be pre-set or limited, to satisfy the multiple communication possibilities of the water pump. As such, the predetermined time duration may be pre-set based on the powered-on time duration of the water pump, and the number of detections may be limited by the predetermined time duration. That is, when the current powered-on time duration of the water pump is within (i.e., less than or equal to) the predetermined time duration, steps 301 and 302 may be executed. When the current powered-on time duration is greater than the predetermined time duration, steps 301 and 302 may not be executed.

Step 308: determining the target communication mode of the water pump based on a predetermined operation mode.

Step 309: transmitting first communication information to an external device based on the target communication mode.

In some embodiments, steps 308 and 309 may be the same as steps 206 and 207. Thus, the descriptions of steps 308 and 309 may refer to the descriptions of steps 206 and 207.

In some embodiments, when the current powered-on time duration of the water pump is greater than the predetermined time duration, in addition to executing steps 308 and 309, in some embodiments, it is possible that no step is executed or other steps are executed, which may be configured based on actual needs. The present disclosure does not limit the execution of steps when the current powered-on time duration of the water pump is greater than the predetermined time duration.

Based on the embodiment shown in FIG. 2, the embodiment shown in FIG. 3 adds detection of the powered-on time duration of the water pump. Using the predetermined time duration corresponding to the powered-on time duration as a limit, after the water pump is powered on, continuous detection on the connection data may be performed within the predetermined time duration, to continuously fit the water pump with the first control system and the connection data transmitted by the first control system.

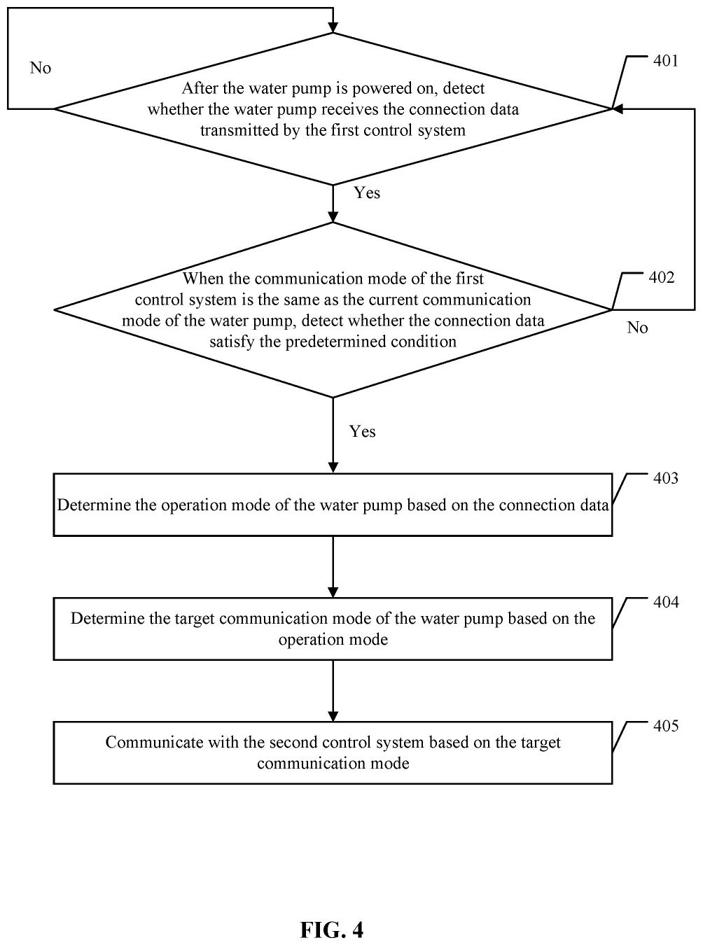

Referring to FIG. 4, another embodiment of the disclosed communication method may include:

Step 401: after the water pump is powered on, detecting whether the water pump receives the connection data transmitted by the first control system; if the water pump receives the connection data, step 402 may be executed; otherwise, step 401 may be repeated.

Step 401 may be the same as step 201 shown in FIG. 2. Thus, the description of step 401 may refer to the description of step 201.

In some embodiments, when the water pump does not receive the connection data transmitted by the first control system, to communicate with the second control system indicated by the connection data transmitted by the first control system, after the water pump is powered on, detection of whether the water pump receives the connection data transmitted by the first control system may be cyclically or repeatedly performed, until it is detected that the water pump receives the connection data transmitted by the first control system. Subsequent processes may be performed.

Step 402: when the communication mode of the first control system is the same as the current communication mode of the water pump, detecting (or determining) whether the connection data satisfy the predetermined condition; if the connection data satisfy the predetermined condition, step 403 may be executed; otherwise, step 401 may be executed.

Step 402 may be the same as step 202 shown in FIG. 2. Thus, the description of step 402 may refer to the description of step 202.

In some embodiments, when the connection data received by the water pump do not satisfy the predetermined condition, because the connection data cannot be correctly interpreted, the water pump cannot communicate with the second control system indicated by the connection data. Detection of whether the water pump receives the connection data transmitted by the first control system may be cyclically or repeatedly performed, until it is detected that the water pump receives the connection data transmitted by the first control system. Then subsequent detection or determination of whether the connection data satisfy the predetermined condition may be performed.

In some embodiments, when for the first time it is detected that the water pump does not receive the connection data transmitted by the first control system or that the received connection data do not satisfy the predetermined condition, detection of whether the water pump receives the connection data transmitted by the first control system may be periodically performed based on a predetermined time period. That is, the detection may be repeatedly performed based on a predetermined time interval.

In some embodiments, a time duration corresponding to the predetermined time period may be not smaller than a total time duration for executing steps 401-402, so as to avoid repeated execution of step 401 when the connection data satisfy the predetermined condition.

In some embodiments, through steps 401-402, it is understood that when the water pump receives the connection data and when the connection data satisfy the predetermined condition, the cyclic or repeated execution of step 401 or steps 401-402 may be terminated.

In some embodiments, when the communication mode of the first control system is different from the current communication mode of the water pump, cyclic or repeated detection of whether the water pump receives the connection data transmitted by the first control system may be performed, until it is detected that the water pump receives the connection data transmitted by the first control system. When the communication mode of the first control system is the same as the current communication mode of the water pump, subsequent detection (or determination) of whether the connection data satisfy the predetermined condition may be performed.

Step 403: determining the operation mode of the water pump based on the connection data.

Step 404: determining the target communication mode of the water pump based on the operation mode.

Step 405: communicating with the second control system based on the target communication mode.

Steps 403-405 of the embodiment shown in FIG. 4 may be the same as steps 203-205 shown in FIG. 2. Thus, descriptions of steps 403-405 may refer to the descriptions of steps 203-205 above.

In some embodiments, different from the embodiments shown in FIG. 2 and FIG. 3, in the embodiment shown in FIG. 4, after the water pump is powered on, if the connection data are not received or if the received connection data do not satisfy the predetermine condition, related detections of the connection data may be continuously performed until the water pump can communicate with a fitting second control system.

In any of the disclosed embodiments, the water pump may be provided with one or more communication modes. When the current communication mode of the water pump does not match with the communication mode of the first control system, the current communication mode of the water pump may be switched to match with the communication mode of the first control system. Next, this feature is further explained based on FIG. 2.

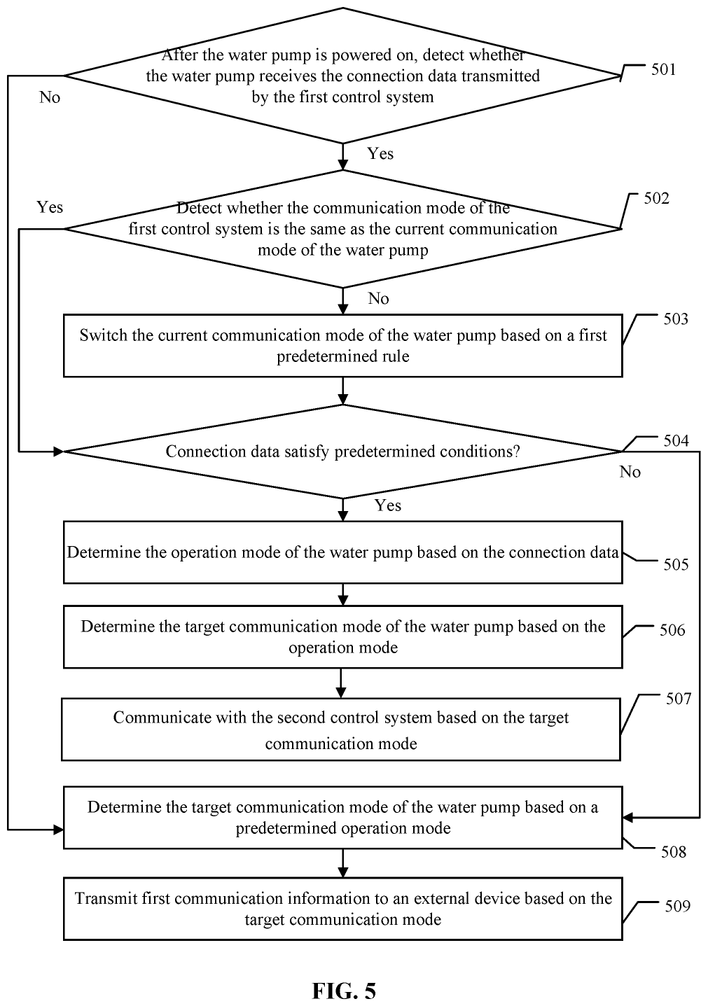

Referring to FIG. 5, another embodiment of the disclosed communication method may include:

Step 501: after the water pump is powered on, detecting whether the water pump receives the connection data transmitted by the first control system; if the water pump receives the connection data, step 502 may be executed; otherwise, step 508 may be executed.

Step 501 of the embodiment shown in FIG. 5 may be the same as step 201 of the embodiment shown in FIG. 2. Thus, descriptions of step 501 may refer to the descriptions of step 201.

Step 502: detecting whether the communication mode of the first control system is the same as the current communication mode of the water pump; if the communication mode of the first control system is not the same as the current communication mode of the water pump, step 503 may be executed; if the communication mode of the first control system is the same as the current communication mode of the water pump, step 504 may be executed.

Description of content included in step 502 may refer to the description of content included in step 202 in the embodiment shown in FIG. 2.

Step 503: switching the current communication mode of the water pump based on a first predetermined rule.

In some embodiments, if the communication mode of the first control system is different from the current communication mode of the water pump, the current communication mode of the water pump may be switched based on the first predetermined rule.

In some embodiments, one or more communication modes may be provided at the water pump. When there are multiple communication modes, and when the communication mode of the first control system is different from the current communication mode of the water pump, the current communication mode of the water pump may be switched based on the first predetermined rule. In some embodiments, every time the current communication mode of the water pump is switched, a detection of whether the communication mode of the first control system is the same as the current communication mode of the water pump may be performed, until the current communication mode of the water pump after the switch is the same as the communication mode of the first control system.

In some embodiments, the first predetermined rule may be configured based on actual needs. For example, the first predetermine rule may include switching between multiple communication modes in turn, switching between multiple communication modes based on an order of high frequency of use to low frequency of use, or switching from the last used communication mode. In some embodiments, the first predetermined rule may be the same as or may be different from the second predetermined rule, which is not limited by the present disclosure.

In some embodiments, the embodiment shown in FIG. 5 may be suitable for the situation where the water pump and the first control system have a pre-arranged corresponding communication mode. That is, when the first control system transmits the connection data, the water pump may not have knowledge about which communication mode is used to transmit the connection data by the first control system. But because the water pump and the first control system have a pre-arranged communication mode, the current communication mode of the water pump may be switched to match the pre-arranged communication mode of the first control system.

In some embodiments, if the water pump does not have a pre-arranged communication mode with the first control system, then when all of the communication modes provided at the water pump do not match with the communication mode of the first control system, steps 507-508 may be executed.

Step 504: detecting whether the connection data satisfy the predetermined condition; if the connection data satisfy the predetermined condition, step 505 may be executed; otherwise, step 508 may be executed.

In some embodiments, when the current communication mode of the water pump is switched to be the same as the communication mode of the first control system, or if the current communication mode of the water pump is the same as the communication mode of the first control system, a detection of whether the connection data satisfy the predetermined condition may be performed.

Step 504 may be the same as step 202 of the embodiment shown in FIG. 2. Thus, description of step 504 may refer to the description of step 202 above.

Step 505: determining the operation mode of the water pump based on the connection data.

Step 506: determining the target communication mode of the water pump based on the operation mode.

Step 507: communicating with the second control system based on the target communication mode.

Step 508: determining the target communication mode of the water pump based on a predetermined operation mode.

Step 509: transmitting first communication information to an external device based on the target communication mode.

Steps 505-509 may be the same as steps 203-207 of the embodiment shown in FIG. 2. Thus, descriptions of steps 505-509 may refer to descriptions of steps 203-207 above.

Compared to the embodiment shown in FIG. 2, in the embodiment shown in FIG. 5, when the current communication mode of the water pump is different from the communication mode of the first control system, the current communication mode of the water pump may be switched to match with the communication mode of the first control system, rather than to continuously obtain connection data transmitted by the first control system that has a communication mode that is the same as the current communication mode of the water pump. The communication method shown in FIG. 5 may increase the communication efficiency between the water pump and the second control system indicated by the connection data transmitted by the first control system.

In some embodiments, the connection data may include, but not be limited to, two data types, such as bus data or pulse signals. Different data types of the connection data correspond to different detection methods for detecting whether the connection data satisfy the predetermined condition. Next, the bus data and the pulse signals are explained based on the embodiment shown in FIG. 2.

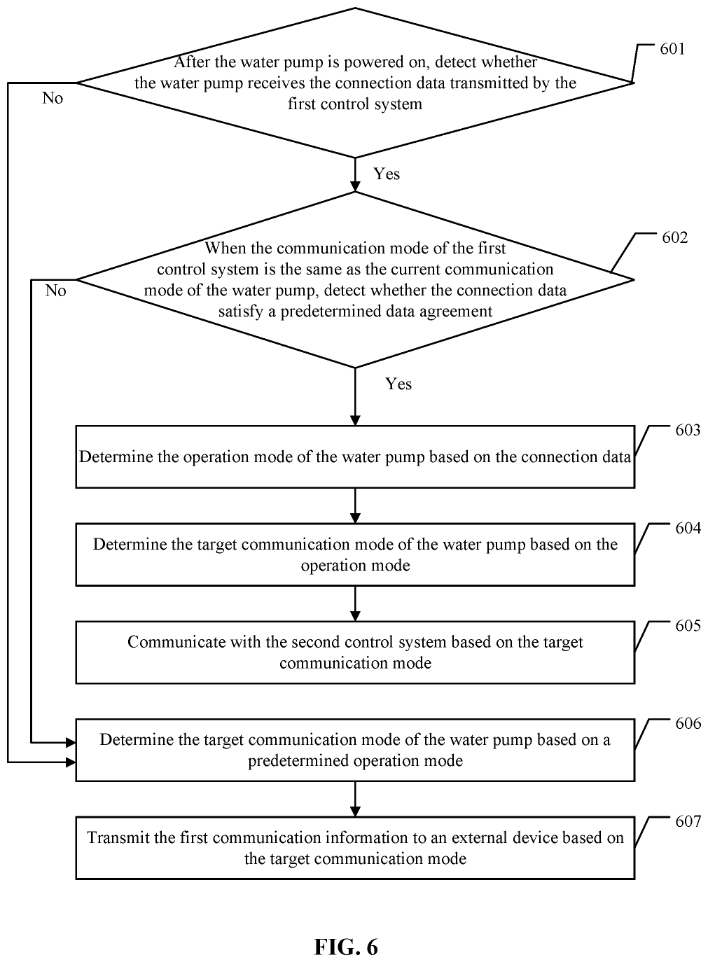

Referring to FIG. 6, another embodiment of the disclosed communication method may include:

Step 601: after the water pump is powered on, detecting whether the water pump receives the connection data transmitted by the first control system; if the water pump receives the connection data, step 602 may be executed; otherwise, step 606 may be executed.

Step 601 may be the same as step 201 of the embodiment shown in FIG. 2. Thus, description of step 601 may refer to the description of step 201 above.

Step 602: when the communication mode of the first control system is the same as the current communication mode of the water pump, detecting whether the connection data satisfy a predetermined data agreement; if the connection data satisfy the predetermined data agreement, step 603 may be executed; otherwise, step 606 may be executed.

In some embodiments, at the water pump, by designing the communication interface, after receiving the connection data, the data type of the connection data may be determined based on the type of the communication interface. When it is determined that the connection data are bus data, a detection may be performed to determine whether the connection data satisfy the predetermined data agreement.

In some embodiments, bus data may include, but not be limited to, one or more of serial interface data, inter-integrated circuit (“IIC”) data, serial peripheral interface (“SPI”) data, l-wire bus data, controller area network (“CAN”) bus data. Different bus data may correspond to the same predetermined data agreement. After the connection data are received, the connection data may be interpreted. The interpreted connection data may be compared with the predetermined data agreement to detect whether the connection data satisfy the predetermined data agreement.

Step 603: determining the operation mode of the water pump based on the connection data.

Step 604: determining the target communication mode of the water pump based on the operation mode.

Step 605: communicating with the second control system based on the target communication mode.

Step 606: determining the target communication mode of the water pump based on a predetermined operation mode.

Step 607: transmitting the first communication information to an external device based on the target communication mode.

Steps 603-607 may be the same as steps 203-207. Thus, descriptions of steps 603-607 may refer to the descriptions of steps 203-207.

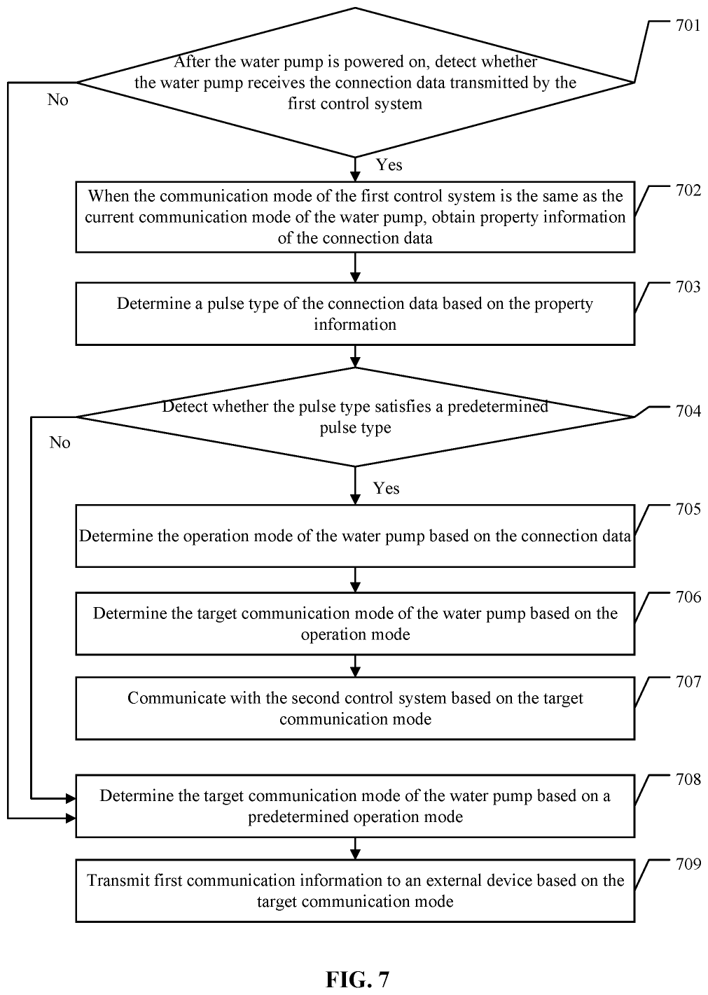

Referring to FIG. 7, another embodiment of the disclosed communication method may include:

Step 701: after the water pump is powered on, detecting whether the water pump receives the connection data transmitted by the first control system; if the water pumps receives the connection data, step 702 may be executed; otherwise, step 708 may be executed.

Step 701 may be the same as step 201 of the embodiment shown in FIG. 2. Thus, description of step 701 may refer to description of step 201 above.

Step 702: when the communication mode of the first control system is the same as the current communication mode of the water pump, obtaining property information of the connection data.

In some embodiments, at the water pump, by designing the communication interface, after the connection data are received, the data type of the connection data may be determined based on the type of the communication interface. When the connection data are determined to be pulse signals, the property information of the connection data may be obtained.

In some embodiments, different property information may indicate different pulse signals. For example, the property information may reflect the pulse type of the pulse signals. In some embodiments, the property information may include, but not be limited to, one or more of a pulse frequency, the number of pulses, a pulse time period, a time for a pulse voltage, and a pulse width modulation (“PWM”) of the pulse.

Step 703: determining a pulse type of the connection data based on the property information.

In some embodiments, after obtaining the property information of the connection data, the pulse type of the connection data may be determined based on the property information.

Step 704: detecting whether the pulse type satisfies a predetermined pulse type; if the pulse type satisfies the predetermined pulse type, step 705 may be executed; otherwise, step 708 may be executed.

In some embodiments, after the pulse type of the connection data is determined based on the property information, whether the pulse type satisfies the predetermined pulse type may be detected.

In some embodiments, one or more predetermined pulse types may be provided at the water pump. In some embodiments, each predetermined pulse type may be configured based on a predetermined range of at least one of a pulse frequency, the number of pulses, a pulse time period, a time for a pulse voltage, and a pulse width modulation (“PWM”) of the pulse. In some embodiments, each predetermined pulse type may be configured based on a predetermined value of at least one of a pulse frequency, the number of pulses, a pulse time period, a time for a pulse voltage, and a pulse width modulation (“PWM”) of the pulse.

In some embodiments, the pulse type of the connection data may be compared with each predetermined pulse type. If the pulse type of the connection data matches one of the predetermined pulse types, it may be determined that the connection data satisfy the predetermined condition. If the pulse type of the connection data does not match any of the predetermined pulse types, it may be determined tha the connection data do not satisfy the predetermined condition.

Step 705: determining the operation mode of the water pump based on the connection data.

Step 706: determining the target communication mode of the water pump based on the operation mode.

Step 707: communicating with the second control system based on the target communication mode.

Step 708: determining the target communication mode of the water pump based on a predetermined operation mode.

Step 709: transmitting first communication information to an external device based on the target communication mode.

Steps 705-709 may be the same as steps 203-207. Thus, descriptions of steps 705-709 may refer to the descriptions of steps 203-207.

The embodiments shown in FIG. 6 and FIG. 7 provide methods for detecting the connection data based on the data type of the connection data. The methods enhance the correspondence between different methods and different data types of the connection data. The methods also avoid low detection efficiency caused by unclear detection methods. Furthermore, using different detection methods for different data types can reduce the decryption difficulty of the detection methods, thereby enhancing communication security.

In some embodiments, while the water pump communicates with the second control system based on the target communication mode, related communication information may be transmitted, and related communication information may be received. Based on the embodiment shown in FIG. 2, the transmitting and receiving of the related communication information will be explained below:

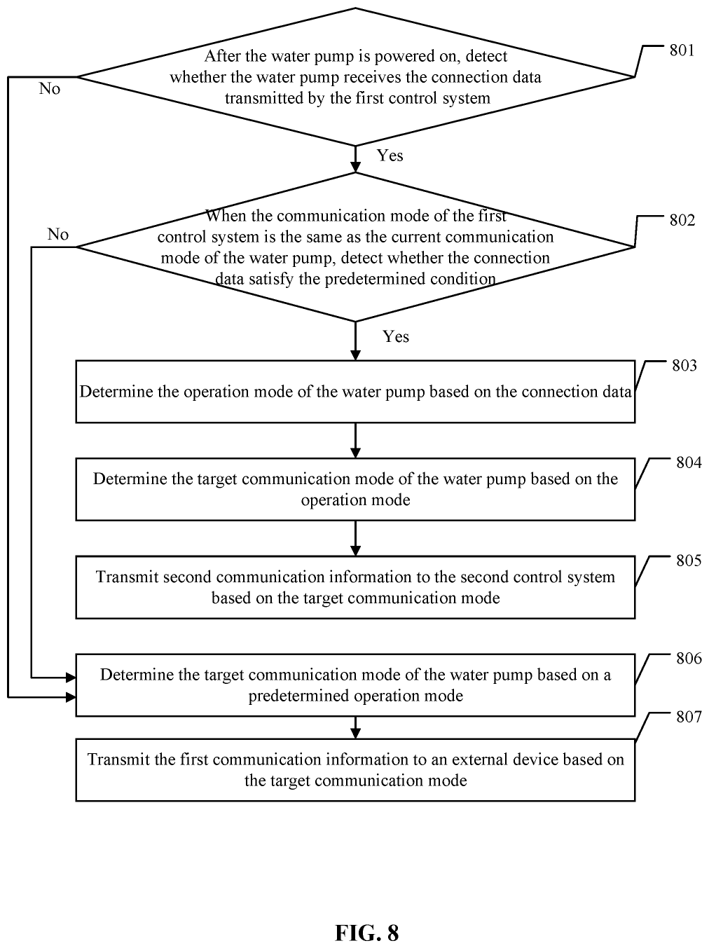

Referring to FIG. 8, another embodiment of the disclosed communication method may include:

Step 801: after the water pump is powered on, detecting whether the water pump receives the connection data transmitted by the first control system; if the water pump receives the connection data, step 802 may be executed; otherwise, step 806 may be executed.

Step 802: when the communication mode of the first control system is the same as the current communication mode of the water pump, detecting whether the connection data satisfy the predetermined condition; if the connection data satisfy the predetermined condition, step 803 may be executed; otherwise, step 806 may be executed.

Step 803: determining the operation mode of the water pump based on the connection data.

Step 804: determining the target communication mode of the water pump based on the operation mode.

Steps 801-804 may be the same as steps 201-204 of the embodiment shown in FIG. 2. Thus, descriptions of steps 801-804 may refer to the descriptions of steps 201-204 above.

Step 805: transmitting second communication information to the second control system based on the target communication mode.

In some embodiments, after the target communication mode of the water pump is determined, second communication information may be transmitted to the second control system based on the target communication mode.

In some embodiments, content information of the connection data may instruct the water pump to transmit the second communication information to the second control system. Based on the demand type of the second control system, corresponding second communication information may be determined. The method for determining the second communication information may include any of the following methods:

1. The operation mode may correspond to the demand type of the second control system. That is, different second control systems may include different demand types. For the same operation mode, it may be further divided into different classifications based on the demand type, such as sub-operation modes. Each demand type may indicate the communication information to be communicated in a corresponding sub-operation mode. As such, if the received connection data satisfy the predetermined condition, an operation mode of the water pump may be determined based on the content information of the connection data. Then, the sub-operation mode under the operation mode may be determined for the water pump based on the demand type of the second control system. The content of the second communication information may be determined based on the sub-operation mode. The second communication information may be transmitted to the second control system based on the target communication mode.

2. The operation mode does not correspond to the demand type of the second control system. That is, the operation mode is not further divided into different classifications based on the demand types of the second control system. As such, if the received connection data satisfy the predetermined condition, the operation mode of the water pump may be determined based on the content information of the connection data. The content of the second communication information may be determined based on the demand type of the second control system (the demand type of the second control system may be determined prior to determining the content of the second communication information). The second communication information may be transmitted to the second control system based on the target communication mode.

Step 806: determining the target communication mode of the water pump based on a predetermined operation mode.

Step 807: transmitting the first communication information to an external device based on the target communication mode.

In some embodiments, the first communication information or the second communication information may include, but not be limited to, at least one of an operation time of the water pump (the operation time may be a total time duration of the water pump being powered on, a total spray time duration of the water pump, etc.), an operation status of the water pump (the operation status may be a status of the water pump being powered on, a spray status of the water pump, etc.), an operation life of the water pump, a remaining operation life of the water pump, a version of the water pump, hardware information of the water pump, manufacturing information of the water pump, environmental information of the water pump, operation information of the water pump, etc. The environmental information may include, but not be limited to, temperature information and/or humidity information. The operation information may include, but not be limited to, at least one of an operation current, an operation voltage, fluid pressure information, fluid velocity information, etc.

In some embodiments, multiple sensors may be provided at the water pump to obtain related information, such as a temperature sensor configured to acquire temperature information of the environmental information of the water pump.

Steps 806-807 may be the same as steps 206-207 of the embodiment shown in FIG. 2. Thus, descriptions of steps 806-807 may refer to the descriptions of steps 206-207.

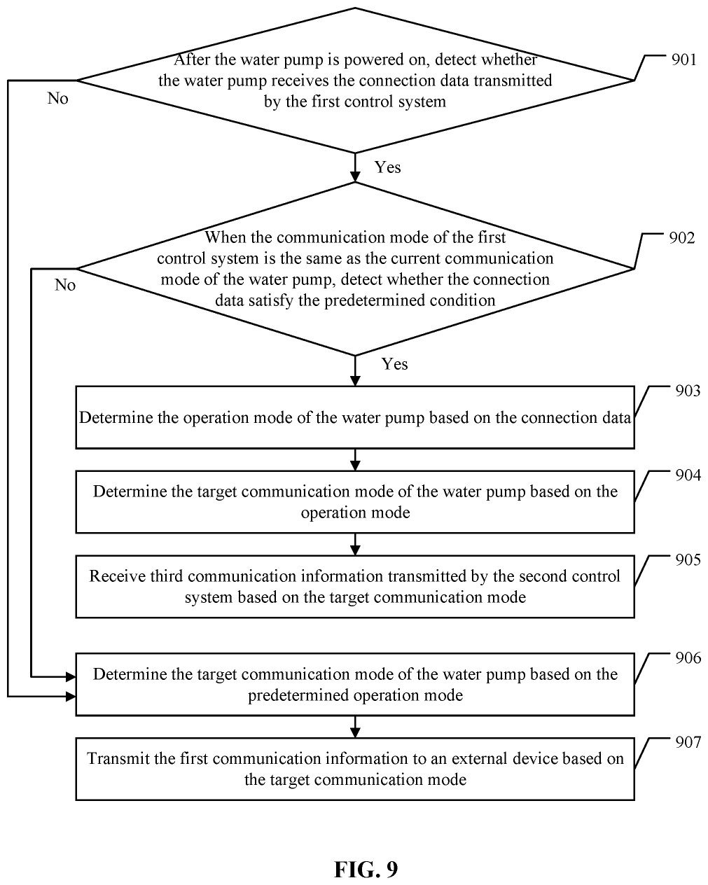

Referring to FIG. 9, another embodiment of the disclosed communication method may include:

Step 901: after the water pump is powered on, detecting whether the water pump receives the connection data transmitted by the first control system; if the water pump receives the connection data, step 902 may be executed; otherwise, step 906 may be executed.

Step 902: when the communication mode of the first control system is the same as the current communication mode of the water pump, detecting whether the connection data satisfy the predetermined condition; if the connection data satisfy the predetermined condition, step 903 may be executed; otherwise, step 906 may be executed.

Step 903: determining that the communication mode of the first control system is the same as the current communication mode of the water pump and determining the operation mode of the water pump based on the connection data.

Step 904: determining the target communication mode of the water pump based on the operation mode.

Steps 901-904 may be the same as steps 201-204 of the embodiment shown in FIG. 2. Thus, descriptions of steps 901-904 may refer to the descriptions of steps 201-204.

Step 905: receiving third communication information transmitted by the second control system based on the target communication mode.

In some embodiments, after determining the target communication mode of the water pump, the third communication information may be transmitted to the second control system based on the target communication mode.

In some embodiments, when the water pump communicates with the second control system based on the target communication mode, in addition to transmitting the second communication information to the second control system, the water pump may receive the third communication information transmitted by the second control system based on the target communication mode.

In some embodiments, after determining the target communication mode, the current communication mode of the water pump may be adjusted to be the target communication mode, i.e., the communication mode of the second control system. Because the communication mode of the water pump and the communication mode of the second control system are both the target communication mode, the second control system may transmit the third communication information to the water pump. The water pump may receive the third communication information, thereby realizing communication exchange.

In some embodiments, the third communication information may include, but not be limited to, control information and/or inquiry information. The control information may include, but not be limited to, shut down instruction information or start up instruction information. The shut down instruction information may be configured to shut down the water pump. The start up instruction information may be configured to start up the water pump. The inquiry information may be configured to obtain related operation information of the water pump, such as operation status information of the water pump, operation time of the water pump, etc. After the water pump receives such information, the water pump may feed back the content inquired by the second control system to the second control system.

Step 906: determining the target communication mode of the water pump based on a predetermined operation mode.

Step 907: transmitting the first communication information to an external device based on the target communication mode.

Steps 906-907 may be the same as steps 206-207. Thus, the descriptions of steps 906-907 may refer to the descriptions of steps 206-207.

In any of the above embodiments, the first control system may include, but not be limited to, one or more of a control system of the movable platform, a spray system of the movable platform, an external communication device of the movable platform, etc.

In some embodiments, when the first control system is the control system of the movable platform or the spray system of the movable platform, the second control system may be the first control system. That is, the control system of the movable platform or the spray system of the movable platform may communicate with the water pump to obtain related information of the water pump. When the first control system is an external communication device of the movable platform, the second control system may be different from the first control system. The second control system may be a backend service system of the movable platform, such as a post-sales service system. The external communication device may be provided at the water pump, operated as a part of the water pump, or may be operated as an independent device.

In some embodiments, the movable platform may include, but not be limited to, a movable object on the ground, in the water, or in the air. In some embodiments, the movable platform is a UAV used in agriculture.

The above describes the communication method from the perspective of the water pump. Next, based on the embodiment shown in FIG. 1, the communication method of the water pump will be described interactively.

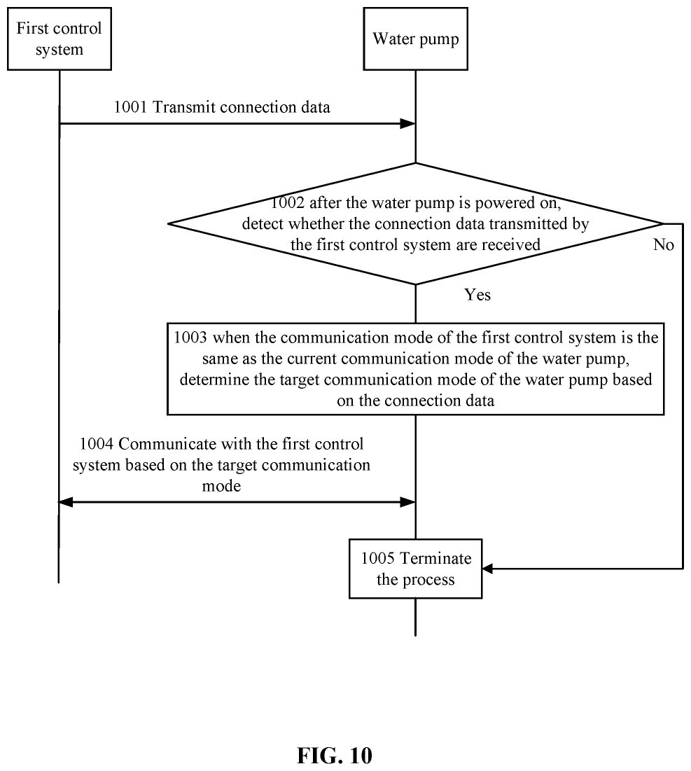

As shown in FIG. 10, in some embodiments, the second control system may be the same as the first control system.

Step 1001: the first control system may transmit the connection data to the water pump.

Step 1002: after the water pump is powered on, the water pump may detect whether the connection data transmitted by the first control system are received; if the connection data are received, step 1003 may be executed; otherwise, step 1005 may be executed.

Step 1003: when the communication mode of the first control system is the same as the current communication mode of the water pump, the water pump may determine the target communication mode of the water pump based on the connection data.

Step 1004: the water pump may communicate with the first control system based on the target communication mode.

Step 1005: the water pump may terminate the process.

The contents of the embodiment shown in FIG. 10 may refer to the above descriptions of the other embodiments.

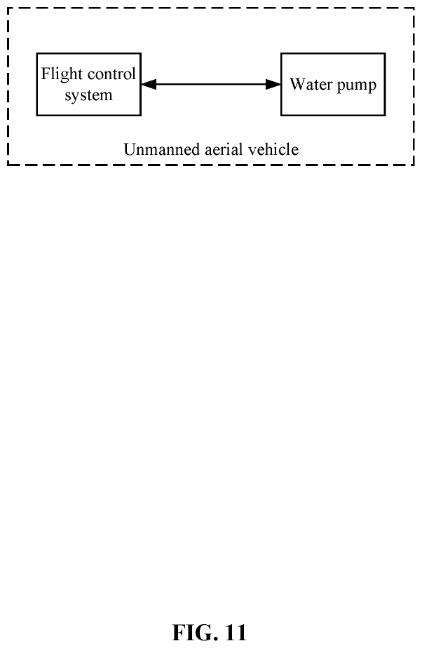

FIG. 11 illustrates a schematic diagram of a UAV. As shown in FIG. 11, when the movable platform is a UAV, the first control system may be a control system of the UAV, e.g., a flight control system. The flight control system of the UAV may transmit the connection data to the water pump. After receiving the connection data, if the current communication mode of the water pump is the same as the communication mode of the flight control system, the water pump may interpret the connection data, and may communicate with the flight control system based on the target communication mode (e.g., the current communication mode) and based on the interpreted connection data. For example, the water pump may transmit operation status information of the water pump to the flight control system.

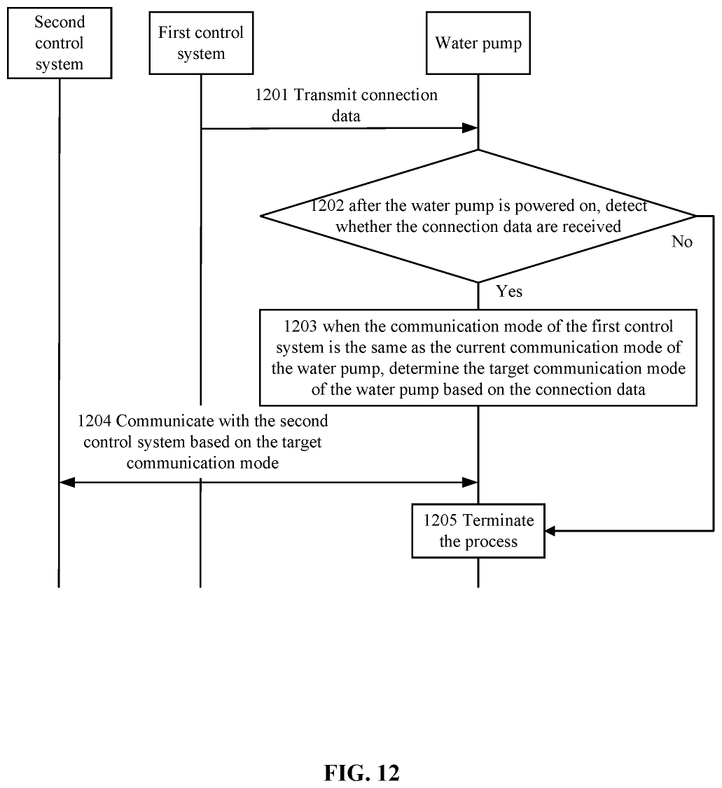

FIG. 12 interactively illustrates the disclosed communication method when the second control system is different from the first control system.

Step 1201: the first control system may transmit the connection data to the water pump.

Step 1202: after the water pump is powered on, the water pump may detect whether the connection data transmitted by the first control system are received; if the connection data are received, step 1203 may be executed; otherwise, step 1205 may be executed.

Step 1203: when the communication mode of the first control system is the same as the current communication mode of the water pump, the water pump may determine the target communication mode of the water pump based on the connection data.

Step 1204: the water pump may communicate with the second control system based on the target communication mode.

Step 1205: the water pump may terminate the process.

Detailed descriptions of the relevant contents of the embodiment shown in FIG. 12 may refer to the descriptions of the above embodiments.

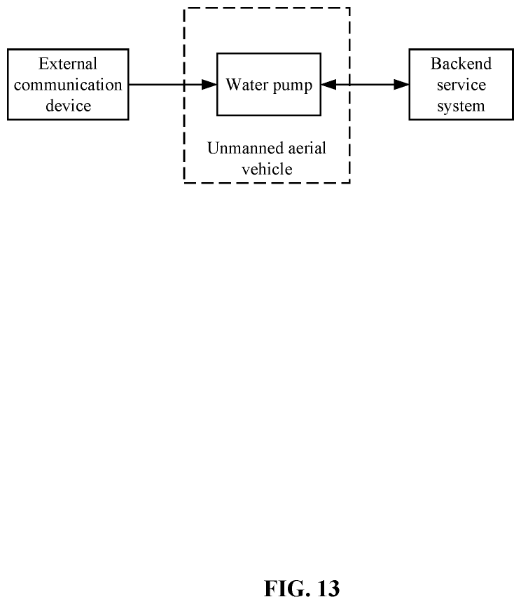

As shown in FIG. 13, when the movable platform is the UAV, the first control system may be an external communication device of the UAV (assuming the external device is an independent device), such as external peripheral hardware. The external communication device may transmit the connection data to the water pump. After receiving the connection data, if the current communication mode of the external communication device is the same as the communication mode of the flight control system of the UAV, the water pump may interpret the connection data, and may determine the second control system, i.e., the communication target of the water pump, based on the interpreted connection data. The second control system may be a backend service system of the UAV. The water pump may determine the target communication mode for communicating with the backend service system of the UAV, such that the water pump may communicate with the backend service system of the UAV based on the target communication mode. For example, the water pump may transmit one or more of the following information to the backend service system: the operation status of the water pump, the operation time of the water pump, the operation life of the water pump, the remaining operation life of the water pump, the version of the water pump, hardware information of the water pump, manufacturing information of the water pump, environmental information of the water pump, or the operation information of the water pump, etc. The backend service system may analyze and investigate information received from the water pump.

The communication method of the present disclosure has been described above. Next, a communication device will be described.

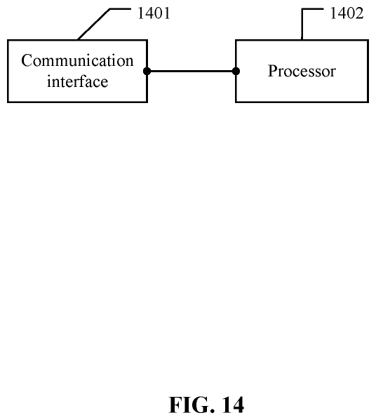

Referring to FIG. 14, the communication device may be used in a movable platform. The movable platform may include the water pump configured to spray fluid. An embodiment of the communication device may include:

a communication interface 1401 and a processor 1402.

The processor 1402 may be configured to:

after the water pump is powered on, detect whether the communication interface 1401 corresponding to the water pump receives the connection data transmitted by the first control system; and

if the connection data are received, and if the communication mode of the first control system is the same as the current communication mode of the water pump, determine the target communication mode of the water pump based on the connection data.

The communication interface 1401 may be configured to:

communicate with the second control system based on the target communication mode; the second control system being indicated by the connection data.

In some embodiments, the communication interface 1401 may receive the connection data transmitted by the first control system. The processor 1402 may detect whether the communication interface 1401 receives the connection data. When the processor 1402 determines that the communication interface 1401 corresponding to the water pump receives the connection data, and when the processor 1402 determines that the communication mode of the first control system is the same as the current communication mode of the water pump, the processor 1402 may determine the target communication mode of the water pump based on the connection data, such that the communication interface 1401 may communicate with the second control system indicated by the connection data based on the target communication mode. As such, through the disclosed communication method, the second control system may communicate with the water pump, to obtain related operation information of the water pump through a simple, straightforward, and convenient manner, rather than merely obtaining the manufacturing information. The disclosed communication method enables the second control system to analyze and investigate the operations of the water pump based on the obtained communication information, and to determine damages, cause of the damages, and responsibility to the damages when the water pump is damaged. As described, one or more communication modes may be provided at the water pump. The disclosed communication method supports switching between multiple communication modes, which makes the water pump suitable for multiple application scenes.

In some embodiments, the processor 1402 may be configured to:

detect whether the connection data satisfy a predetermined condition; and

if the connection data satisfy the predetermined condition, determine the communication mode of the first control system as the current communication mode of the water pump.

In some embodiments, the processor 1402 may be configured to:

determine an operation mode of the water pump based on the connection data; and

determine a target communication mode of the water pump based on the operation mode.

In some embodiments, the processor 1402 may be configured to:

if the water pump does not receive the connection data, or if the received connection data do not satisfy the predetermined condition, determine the target communication mode of the water pump based on a predetermined operation mode.

In some embodiments, the communication interface 1401 may be configured to:

transmit first communication information to an external device based on the target communication mode.

In some embodiments, the processor 1402 may be configured to:

if the water pump does not receive the connection data, or if the received connection data do not satisfy the predetermined condition, determine the current powered-on time duration of the water pump;

if the current powered-on time duration is not greater than a predetermined time duration, trigger the detection of whether the communication interface corresponding to the water pump receives the connection data transmitted by the first control system;

if the current powered-on time duration is greater than the predetermined time duration, trigger the determination of the target communication mode of the water pump based on a predetermined operation mode.

In some embodiments, the processor 1402 may be configured to:

if the water pump does not receive the connection data, or if the received connection data do not satisfy the predetermined condition, trigger, based on a predetermined time period, the detection of whether the water pump receives the connection data transmitted by the first control system.

In some embodiments, the processor 1402 may be configured to:

if the communication mode of the first control system is different from the current communication mode of the water pump, switch the current communication mode of the water pump based on a first predetermined rule.

In some embodiments, when the connection data are bus data, the processor 1402 may be configured to:

detect whether the connection data satisfy a predetermined agreement; if the connection data satisfy the predetermined agreement, determine that the connection data satisfy the predetermined condition.

In some embodiments, when the connection data are pulse signals, the processor 1402 may be configured to:

obtain property information of the connection data;

determine the pulse type of the connection data based on the property information; and

detect whether the pulse type satisfies (e.g., is the same as) a predetermined pulse type; if the pulse type satisfies the predetermined pulse type, determine whether the connection data satisfy the predetermined condition.

In some embodiments, the communication interface 1401 may be configured to:

transmit second communication information to the second control system based on the target communication mode.

In some embodiments, the processor 1402 may be configured to:

determine content information of the connection data; and

determine the operation mode of the water pump based on the content information.

In some embodiments, the processor 1402 may be configured to:

determine a demand type of the second control system.

In some embodiments, determining the operation mode of the water pump based on the content information may include:

determining the operation mode of the water pump based on the content information and the demand type.

In some embodiments, the processor 1402 may be configured to:

determine the demand type of the second control system; and

determine second communication information based on the demand type.

In some embodiments, the communication interface 1401 may be configured to:

receive third communication information transmitted by the second control system based on the target communication mode.

In some embodiments, the processor 1402 may be configured to:

switch the current communication mode of the water pump based on a second predetermined rule.

In some embodiments, the communication device may include, but not be limited to, a communication interface, a processor, etc. A person having ordinary skills in the art can appreciate that the embodiment shown in FIG. 14 is an example of the disclosed communication device, and does not limit the disclosed communication device. For example, the communication device may include more or fewer elements or components than what are shown in FIG. 14, a combination of certain elements, or different elements. For example, the communication device may also include an input/output device, a network connection device, a data storage device, etc.

In some embodiments, the storage device may be configured to store computer program (e.g., code or instructions). The computer program may be executable by a processor. The computer program may include a series of commands or instructions configured to perform specified functions. The commands may be configured to describe the execution process of the computer program in various parts of the communication device, which may be performed to realize the related functions of the corresponding communication device.

The processor may be a central processing unit (“CPU”). The processor may include in other general processor, such as a digital signal processor (“DSP”), an application-specific integrated circuit (“ASIC”), a programmable logic device (“PLD”), or a combination thereof. The PLD may be a complex programmable logic device (“CPLD”), a field-programmable gate array (“FPGA”), etc. The processor may include other programmable logic devices, discrete gates or transistor logic device, discrete hardware assembly, etc. The general processor may be a microprocessor or any regular processor. The processor may be the control center of the detecting device, and may detect operations of various parts of the detecting device through various interfaces and circuits.

In some embodiments, the data storage device may be configured to store the computer software and/or modules. The processor may be configured to execute or perform the computer software and/or modules stored in the data storage device, to retrieve data stored in the data storage device, and to realize various functions of the detecting device. The data storage device may include a program storage region and a data storage region. The program storage region may be configured to store an operation system, and at least one function-related application software (e.g., sound playback function related software, image display or play related software, etc.). The data storage region may be configured to store data (e.g., voice data, phone contacts, etc.) established based on the operation of a terminal. The data storage device may include a high-speed random access storage device, or a non-volatile storage device. For example, the data storage device may include one or more of a hard disk, a memory, a plug-in hard disk, a smart media card (“SMC”), a secure digital (“SD”) card, a flash card, at least one magnetic storage device, a flash storage device, or other volatile solid-state storage device.

In some embodiments, the present disclosure provides a water pump. The water pump may include the communication device described above. The communication device may communicate with the first control system based on a corresponding communication mode, and/or communicate with the second control system indicated by the first control system based on the corresponding communication mode. During communication, the communication device may transmit related operation information of the water pump to the first control system and/or the second control system, such that the first control system and/or the second control system may obtain the related operation information of the water pump.

In some embodiments, the present disclosure provides a non-transitory computer-readable storage medium. The computer-readable storage medium may be configured to store computer program. The computer program, when executed, may cause the processor to perform the various steps of the disclosed methods.

If the integrated units are realized as software functional units and sold or used as independent products, the integrated units may be stored in a computer-readable storage medium. Based on such understanding, part or all of the disclosed methods of the present disclosure may be realized through a software product instructing related hardware. The computer software product may be storage in a non-transitory storage medium, including instructions or codes for causing a computing device (e.g., personal computer, server, or network device, etc.) to execute some or all of the steps of the disclosed methods. The computer software may include computer software codes. The computer software codes may include source code format, object code format, executable documents, or other intermediate formats. The computer-readable storage medium may include any suitable physical entity, device, or recording medium that can store program codes or instruction, such as at least one of a U disk (e.g., flash memory disk), a mobile hard disk, a magnetic disk an optical disk, a computer storage device, a read-only memory (“ROM”), a random access memory (“RAM”), an electromagnetic wave signal, a telecommunication signal, and software distribution media, etc. The content stored in the computer-readable medium may be increased or reduced based on the laws and patent practice in the related jurisdiction. For example, in certain jurisdictions, due to related patent law and practice, the computer-readable medium may not include the electromagnetic wave signals and the telecommunication signals.

A person having ordinary skills in the art can appreciate, for simplicity and convenience, the descriptions of the operations of the disclosed system, device, and units may refer to the descriptions of the related methods.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

The above descriptions of various embodiments of the disclosed technical solutions are for illustration only, and do not limit the scope of the present disclosure. A person having ordinary skill in the art can modify or improve the various features of the present disclosure without departing from the principle of the various embodiments disclosed herein. Such modification or improvement also fall within the scope of the present disclosure. When no obvious conflict is created, various features shown in various embodiments may be combined in a single embodiment. The descriptions of the various embodiments in this specification are not intended to limit the scope of the present disclosure.

What is claimed is:

1. A communication method for a water pump, comprising:
detecting whether the water pump receives connection data transmitted by a first control system after the water pump is powered on;
determining a target communication mode of the water pump based on the connection data, in response to a detection that the water pump receives the connection data and that a communication mode of the first control system is the same as a current communication mode of the water pump; and
communicating with a second control system indicated by the connection data based on the target communication mode.

2. The communication method of claim 1, wherein determining the target communication mode of the water pump based on the connection data comprises:
determining an operation mode of the water pump based on the connection data; and
determining the target communication mode of the water pump based on the operation mode.

3. The communication method of claim 2, wherein determining the operation mode of the water pump based on the connection data comprises:
determining content information of the connection data; and
determining the operation mode of the water pump based on the content information.

4. The communication method of claim 2, wherein the operation mode comprises at least one of a data output mode, a command input mode, a programming mode, or a data editing mode.

5. The communication method of claim 1, wherein before determining the target communication mode of the water pump based on the connection data, the method further comprises:
detecting whether the connection data satisfy a predetermined condition; and
in response to a detection that the connection data satisfy the predetermined condition, triggering the determination of the target communication mode of the water pump based on the connection data.

6. The communication method of claim 5, further comprising:
in response to a detection that the water pump does not receive the connection data, or that the connection data do not satisfy the predetermined condition, triggering, based on a predetermined time period, the detection of whether the water pump receives the connection data transmitted by the first control system.

7. The communication method of claim 5, further comprising:
in response to a detection that the water pump does not receive the connection data, or the connection data do not satisfy the predetermined condition, determining the target communication mode of the water pump based on a predetermined operation mode; and
transmitting first communication information based on the target communication mode.

8. The communication method of claim 7, further comprising:
in response to a detection that the water pump does not receive the connection data, or the connection data do not satisfy the predetermined condition, determining a current powered-on time duration of the water pump;
in response to a determination that the current powered-on time duration is not greater than a predetermined time duration, triggering the detection of whether the water pump receives the connection data transmitted by the first control system; and
in response to a determination that the current powered-on time duration is greater than the predetermined time duration, triggering the determination of the target communication mode of the water pump based on the predetermined operation mode.

9. The communication method of claim 7, wherein communicating with the second control system based on the target communication mode comprises:
transmitting second communication information to the second control system based on the target communication mode.

10. The communication method of claim 9, wherein before transmitting the second communication information to the second control system based on the target communication mode, the method further comprises:
determining a demand type of the second control system; and
determining the second communication information based on the demand type.

11. The communication method of claim 9,
wherein at least one of the first communication information or the second communication information comprises at least one of an operation time of the water pump, an operation status of the water pump, an operation life of the water pump, a remaining operation life of the water pump, a version of the water pump, hardware information of the water pump, manufacturing information of the water pump, environmental information of the water pump, or operation information of the water pump.

12. The communication method of claim 9, wherein communicating with the second control system based on the target communication mode comprises:
receiving third communication information transmitted by the second control system based on the target communication mode.

13. The communication method of claim 12, wherein the third communication information comprises at least one of control information or inquiry information.

14. The communication method of claim 2, wherein the connection data comprise at least one of a bus data or a pulse signal.

15. The communication method of claim 14,
wherein when the connection data comprise the bus data, detecting whether the connection data satisfy the predetermined condition comprises:
detecting whether the connection data satisfy a predetermined data agreement; and
determining that the connection data satisfy the predetermined condition based on a determination that the connection data satisfy the predetermined data agreement.

16. The communication method of claim 14,
wherein when the connection data comprise the pulse signal, detecting whether the connection data satisfy the predetermined condition comprises:
obtaining property information of the connection data;
determining a pulse type of the connection data based on the property information;
detecting whether the pulse type satisfies a predetermined pulse type; and
determining that the connection data satisfy the predetermined condition in response to a detection that the pulse type satisfies the predetermined pulse type.

17. The communication method of claim 1, further comprising:
switching the current communication mode of the water pump based on a first predetermined rule in response to a determination that the communication mode of the first control system is not the same as the current communication mode of the water pump.

18. The communication method of claim 17, wherein before detecting whether the water pump receives the connection data transmitted by the first control system, the method further comprises:
switching the current communication mode of the water pump based on a second predetermined rule.

19. A water pump, comprising:
a communication interface; and
a processor configured to:
detect whether the water pump receives connection data transmitted by a first control system after the water pump is powered on; and
determine a target communication mode of the water pump based on the connection data, in response to a detection that the water pump receives the connection data and that a communication mode of the first control system is the same as a current communication mode of the water pump;
wherein the communication interface is configured to communicate with a second control system indicated by the connection data based on the target communication mode.

20. An unmanned aerial vehicle, comprising:
a flight control system configured to control flight of the unmanned aerial vehicle; and
a water pump coupled with the flight control system, the water pump comprising:
a communication interface; and
a processor configured to:
detect whether the water pump receives connection data transmitted by a first control system after the water pump is powered on; and
determine a target communication mode of the water pump based on the connection data, in response to a detection that the water pump receives the connection data and that a communication mode of the flight control system is the same as a current communication mode of the water pump;
wherein the communication interface is configured to communicate with a second control system indicated by the connection data based on the target communication mode.
